(19) United States
(12) Patent Application Publication
(10) Pub. No.: US 2003/0018828 A1
(43) Pub. Date: Jan. 23, 2003

(54) Infiniband mixed semantic ethernet I/O path

(75) Inventors: David F. Craddock, New Paltz, NY (US); Ian David Judd, Winchester (GB); Renato John Recio, Austin, TX (US); Lee Anton Sendelbach, Rochester, MN (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/895,226

(22) Filed: Jun. 29, 2001

(51) Int. Cl. G06F 15/16; G06F 13/10

(52) U.S. Cl. 709/321; 709/250

(57) ABSTRACT

A method and system for transmitting and receiving data from a host computer system to an Ethernet adapter are provided. The method comprises establishing a connection between the host system and the Ethernet adapter pushing a transmit or receive request message from a host system device driver to the Ethernet adapter's request queue. Access to host memory is transferred to the Ethernet adapter. If data is being transmitted to the Ethernet adapter, the adapter reads the data from a location in host memory specified in the transmit request message, and then transmits the data onto transmission media (e.g. wire, fiber). If the request message is a receive request, the adapter reads the data from the media and then sends the data into host memory at the location specified in the receive request message. When the data transfer is complete, the adapter sends a response message back to the host. The response message includes a transaction ID which is used by the host device driver to associate the response message to the original request message.

### BACKGROUND OF THE INVENTION

1. Technical Field

The present invention relates generally to communication over a computer network, and more specifically to processing Ethernet mixed semantics Input/Output.

2. Description of Related Art

Ethernet is the most widely-used local area network (LAN) access method. Ethernet transmits variable length frames from 64 to 1518 bytes in length. Each frame contains a header with the addresses of the source and destination stations, and a trailer which contains error correction data. Higher-level protocols fragment long messages into the frame size required by the Ethernet network being employed. Ethernet uses Carrier Sense Multiple Access/ Collision Detection (CSMA/CD) technology to broadcast each frame onto a physical medium (i.e. wire, fiber). All stations attached to the Ethernet are listening, and the station with the matching destination address accepts the frame and checks for errors.

In a System Area Network (SAN), the hardware provides a message passing mechanism which can be used for Input/Output devices (I/O) and interprocess communications between general computing nodes (IPC). Consumers access SAN message passing hardware by posting send/receive messages to send/receive work queues on a SAN channel adapter (CA). The send/receive work queues (WQ) are assigned to a consumer as a queue pair (QP). The messages can be sent over five different transport types: Reliable Connected (RC), Reliable datagram (RD), Unreliable Connected (UC), Unreliable Datagram (UD), and Raw Datagram (RawD). Consumers retrieve the results of these messages from a completion queue (CQ) through SAN send and receive work completions (WC). The source channel adapter takes care of segmenting outbound messages and sending them to the destination. The destination channel adapter takes care of reassembling inbound messages and placing them in the memory space designated by the destination's consumer. Two channel adapter types are present, a host channel adapter (HCA) and a target channel adapter (TCA). The host channel adapter is used by general purpose computing nodes to access the SAN fabric. Consumers use SAN verbs to access host channel adapter functions. The channel interface (CI) interprets verbs and directly accesses the channel adapter.

A Memory Region is an area of memory that is contiguous in the virtual address space and for which the translated physical addresses and access rights have been registered with the HCA. A Memory Window is an area of memory within a previously defined Memory Region, for which the access rights are either the same as or a subset of those of the Memory Region.

Current approaches of copying Ethernet frames to and from a host system rely heavily on interrupts and software. Such an approach requires allocating large amounts of processing power to I/O, rather than handling new requests and other functions.

Therefore, it would be desirable to have a method for transferring Ethernet frames to and from a host which relies more on hardware than software/interrupts and requires less processor intervention.

### SUMMARY OF THE INVENTION

The present invention provides a method and system for transmitting and receiving data from a host computer system to an Ethernet adapter. The method comprises establishing a connection between the host system and the Ethernet adapter pushing a transmit or receive request message from a host system device driver to the Ethernet adapter's request queue. Access to host memory is transferred to the Ethernet adapter. If data is being transmitted to the Ethernet adapter, the adapter reads the data from a location in host memory specified in the transmit request message, and then transmits the data onto transmission media (e.g. wire, fiber). If the request message is a receive request, the adapter reads the data from the media and then sends the data into host memory at the location specified in the receive request message. When the data transfer is complete, the adapter sends a response message back to the host. The response message includes a transaction ID which is used by the host device driver to associate the response message to the original request message.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a diagram of a networked computing system in accordance with a preferred embodiment of the present invention;

FIG. 2 depicts a functional block diagram of a host processor node in accordance with a preferred embodiment of the present invention;

FIG. 3 depicts a diagram of a host channel adapter in accordance with a preferred embodiment of the present invention;

FIG. 4 depicts a diagram illustrating processing of Work Requests in accordance with a preferred embodiment of the present invention;

FIG. 5 depicts a schematic diagram illustrating the relationship between Memory Windows and a Memory Region in accordance with the present invention;

FIG. 6 depicts a schematic diagram illustrating the relationship between IB components executing basic I/O transmit methodology in accordance with the present invention;

FIG. 7 depicts a flowchart illustrating the process flow of I/O transmit methodology in accordance with the present invention;

FIG. 8 depicts a schematic diagram illustrating the relationship between IB components executing an alternate I/O receive methodology in accordance with the present invention; and

FIG. 9 depicts a flowchart illustrating the process flow the alternate I/O receive methodology in accordance with the present invention.

### DETAILED DESCRIPTION OF THE PREFERRED EMBODIMENT

The present invention provides a distributed computing system having end nodes, switches, routers, and links interconnecting these components. Each end node uses send and receive queue pairs to transmit and receive messages. The end nodes segment the message into packets and transmit the packets over the links. The switches and routers interconnect the end nodes and route the packets to the appropriate end node. The end nodes reassemble the packets into a message at the destination.

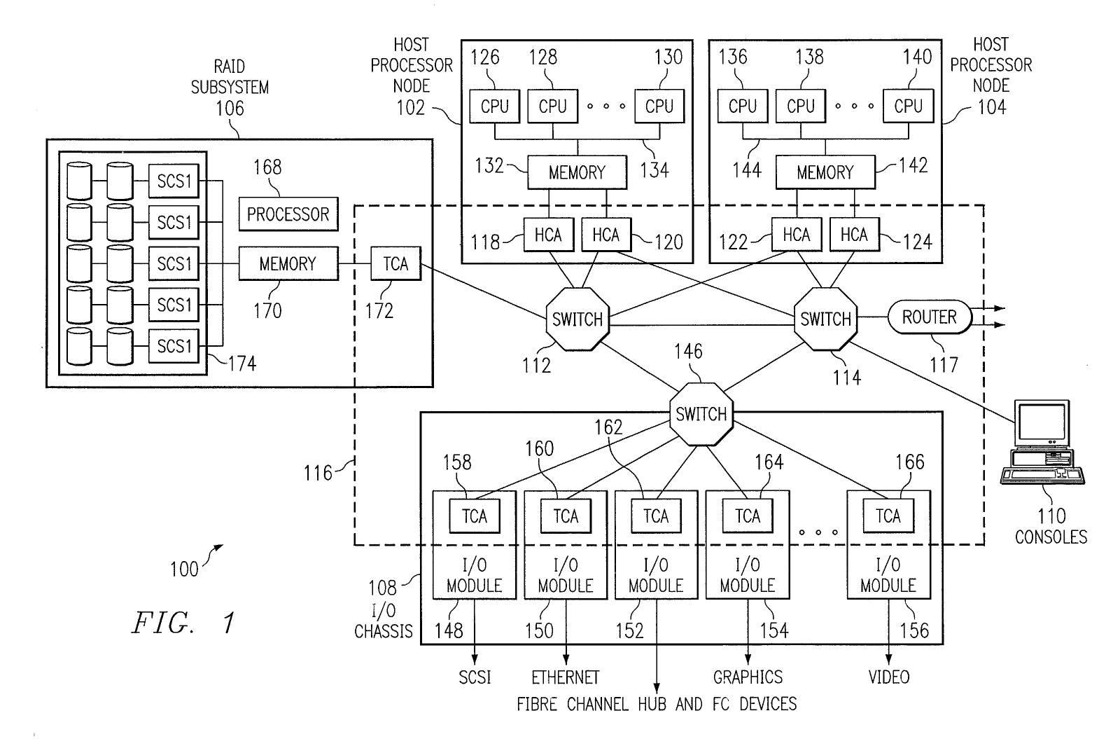

With reference now to the figures and in particular with reference to FIG. 1, a diagram of a networked computing system is illustrated in accordance with a preferred embodiment of the present invention. The distributed computer system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or packets in SAN 100.

In one embodiment of the present invention, an error handling mechanism in distributed computer systems is present in which the error handling mechanism allows for reliable connection or reliable datagram communication between end nodes in a distributed computing system, such as SAN 100.

A message, as used herein, is an application-defined unit of data exchange, which is a primitive unit of communication between cooperating processes. A packet is one unit of data encapsulated by a networking protocol headers and/or trailer. The headers generally provide control and routing information for directing the packets through the SAN. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low latency in a secure, remotely managed environment. Endnodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing packets from one link in a first subnet to another link in a second subnet using a large header Destination Globally Identifier (DGID).

In one embodiment, a link is a full duplex channel between any two network fabric elements, such as endnodes, switches, or routers. Example of suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 100. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers.

The I/O chassis 108 in FIG. 1 include an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in a distributed computer system. With an I/O adapter attached to the SAN 100, the resulting I/O adapter node has substantially the same communication capability as any host processor node in SAN 100.

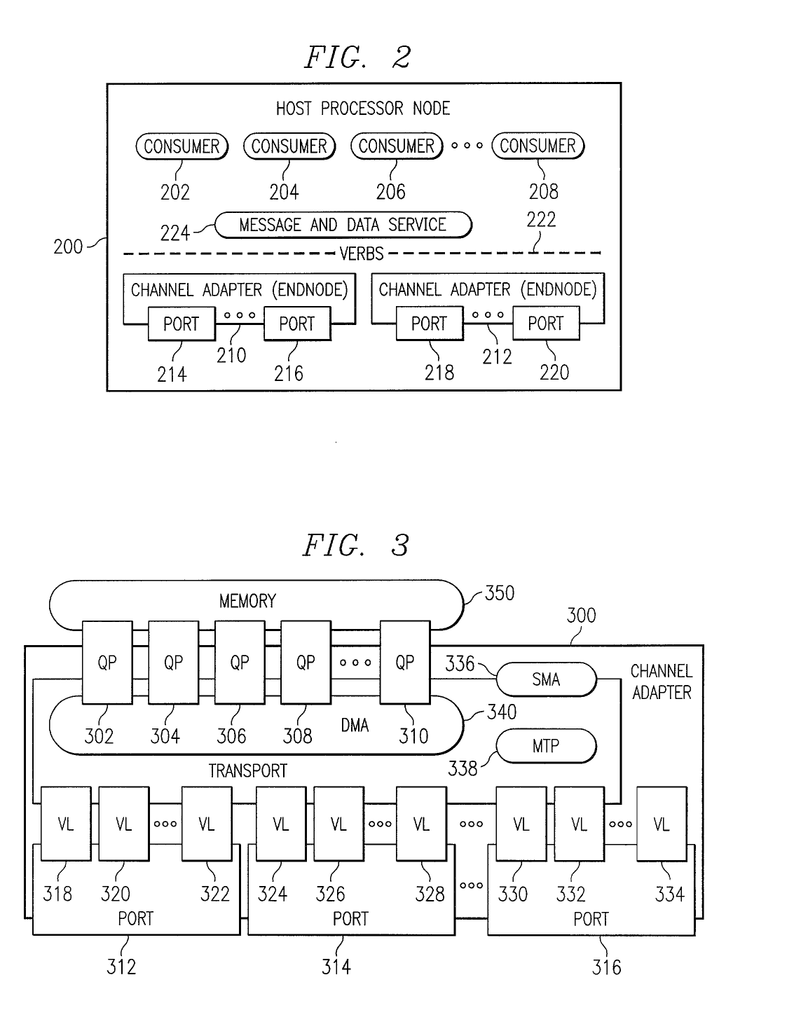

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher level interface than the verb layer and is used to process messages and data received through channel adapter 210 and channel adapter 212. Message and data service 224 provides an interface to consumers 202-208 to process messages and other data.

With reference now to FIG. 3, a diagram of a host channel adapter is depicted in accordance with a preferred embodiment of the present invention. Host channel adapter 300 shown in FIG. 3 includes a set of queue pairs (QPs) 302-310, which are used to transfer messages to the host channel adapter ports 312-316. Buffering of data to host channel adapter ports 312-316 is channeled through virtual lanes (VL) 318-334 where each VL has its own flow control. Subnet manager configures channel adapters with the local addresses for each physical port, i.e., the port's LID. Subnet manager agent (SMA) 336 is the entity that communicates with the subnet manager for the purpose of configuring the channel adapter. Memory translation and protection (MTP) 338 is a mechanism that translates virtual addresses to physical addresses and to validate access rights. Direct memory access (DMA) 340 provides for direct memory access operations using memory 350 with respect to queue pairs 302-310.

A single channel adapter, such as the host channel adapter 300 shown in FIG. 3, can support thousands of queue pairs. By contrast, a target channel adapter in an I/O adapter typically supports a much smaller number of queue pairs.

Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place Work Requests onto a Work Queue (WQ).

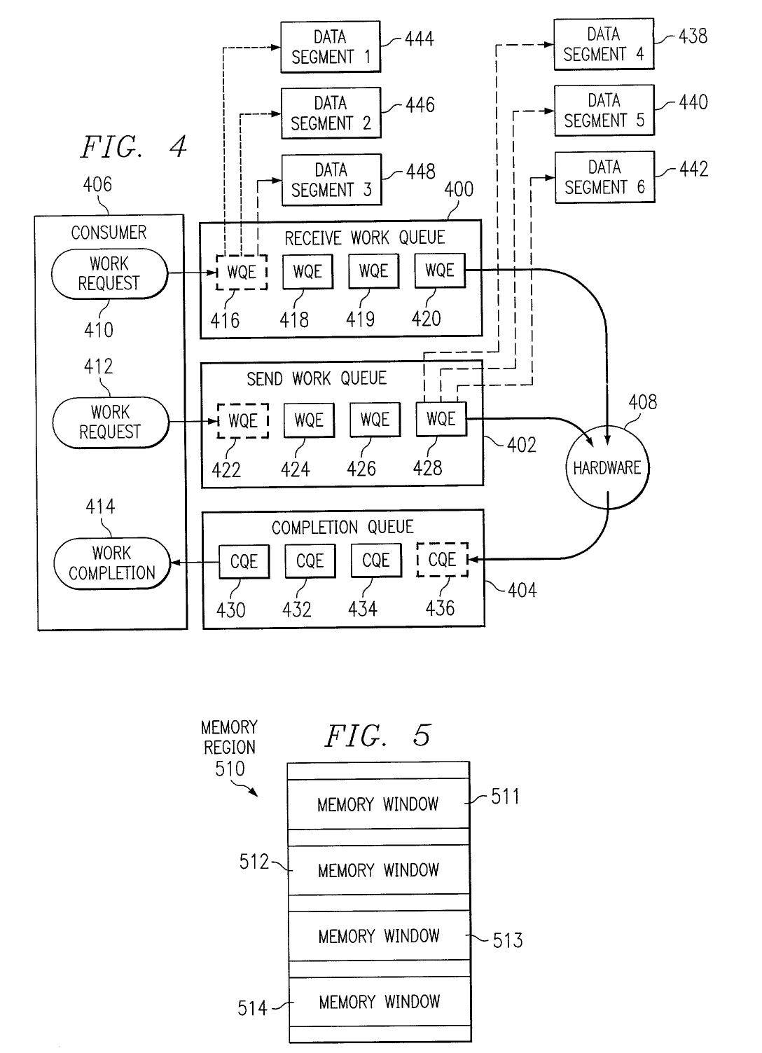

With reference now to FIG. 4, a diagram illustrating processing of Work Requests is depicted in accordance with a preferred embodiment of the present invention. In FIG. 4, a receive work queue 400, send work queue 402, and completion queue 404 are present for processing requests from and for consumer 406. These requests from consumer 406 are eventually sent to hardware 408. In this example, consumer 406 generates Work Requests 410 and 412 and receives work completion 414. As shown in FIG. 4, Work Requests placed onto a work queue are referred to as Work Queue Elements (WQEs).

Send work queue 402 contains Work Queue Elements (WQEs) 422-428, describing data to be transmitted on the SAN fabric. Receive work queue 400 contains WQEs 416-420, describing where to place incoming channel semantic data from the SAN fabric. A WQE is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed Work Queue Elements. Completion queue 404 is used to create a single point of completion notification for multiple queue pairs. A completion queue element is a data structure on a completion queue. This element describes a completed WQE. The completion queue element contains sufficient information to determine the queue pair and specific WQE that completed. A completion queue context is a block of information that contains pointers to, length, and other information needed to manage the individual completion queues.

Example Work Requests supported for the send work queue 402 shown in FIG. 4 are as follows. A send Work Request is a channel semantic operation to push a set of local data segments to the data segments referenced by a remote node's receive WQE. For example, WQE 428 contains references to data segment 4 438, data segment 5 440, and data segment 6 442. Each of the send Work Request's data segments contains a virtually contiguous Memory Region. The virtual addresses used to reference the local data segments are in the address context of the process that created the local queue pair.

Referring to FIG. 5, a schematic diagram illustrating the relationship between Memory Windows and a Memory Region is depicted in accordance with the present invention. A Remote Direct Memory Access (RDMA) Read Work Request provides a memory semantic operation to read a virtually contiguous memory space on a remote node. A memory space can either be a portion of a Memory Region 510 or portion of a Memory Window, such as Windows 511-514. The Memory Region 510 references a previously registered set of virtually contiguous memory addresses defined by a virtual address and length. Memory Windows 511-514 reference sets of virtually contiguous memory addresses which have been bound to a previously registered Memory Region 510.

The present invention provides a method for processing Ethernet mixed semantic I/O over IB using IB's basic and advanced completion mechanisms. During the process of establishing a connection, the adapter passes the adapter's request message queue depth back to the device driver, by using the private data field of the IB Connection Management protocol rely (REP) message. This step is only necessary if the adapter has a variable-depth request queue. During normal operations, the device driver will never let the number of outstanding I/O transactions be larger than the adapter's request queue depth.

During normal operations, the device driver pushes (via an IB Post Send) a Transmit Request message into the adapter's Request receive queue. The adapter interprets the message and, if it is a transmit, the adapter uses a READ RDMA to read the data from host memory at the location specified in the Request message. The data is then transmitted onto media (e.g. wire, cable, fiber). If the Request message is a receive, the adapter reads the data from the media or its adapter buffer and then uses an IB Post Send to send the data into host memory at the location specified in the Request message.

When the data transfer is complete, the adapter sends a Receive Response message back to the host. The response message includes a transaction ID which is used by the host device driver to associate the Response message to the original Request message. The lost device retrieves the Response message as a (receive) work completion.

The present invention allows the transfer of Ethernet frames to and from a host system with much less processor intervention than prior art approaches. The present invention allows direct copying of data from the Ethernet chip to the host without interrupts and no/low software involvement.

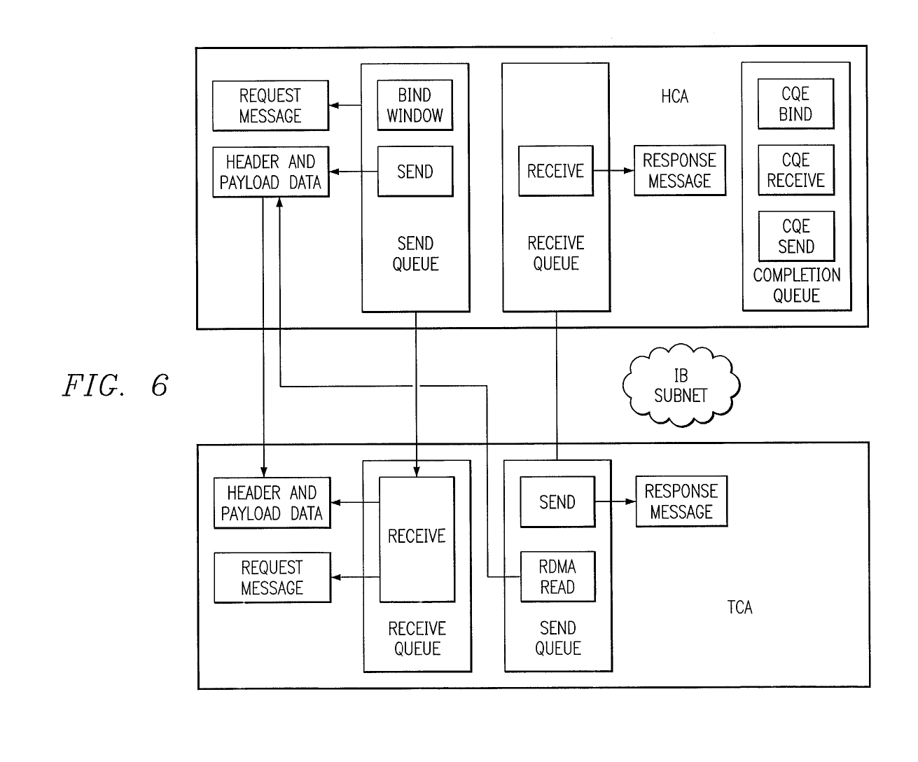

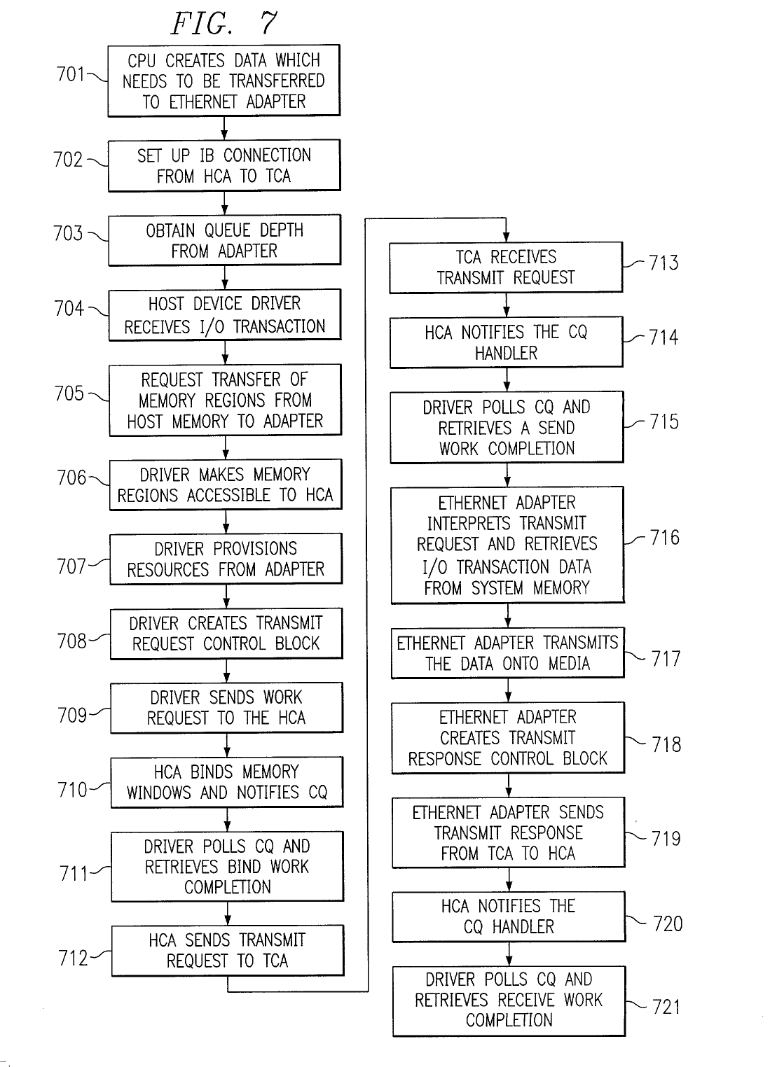

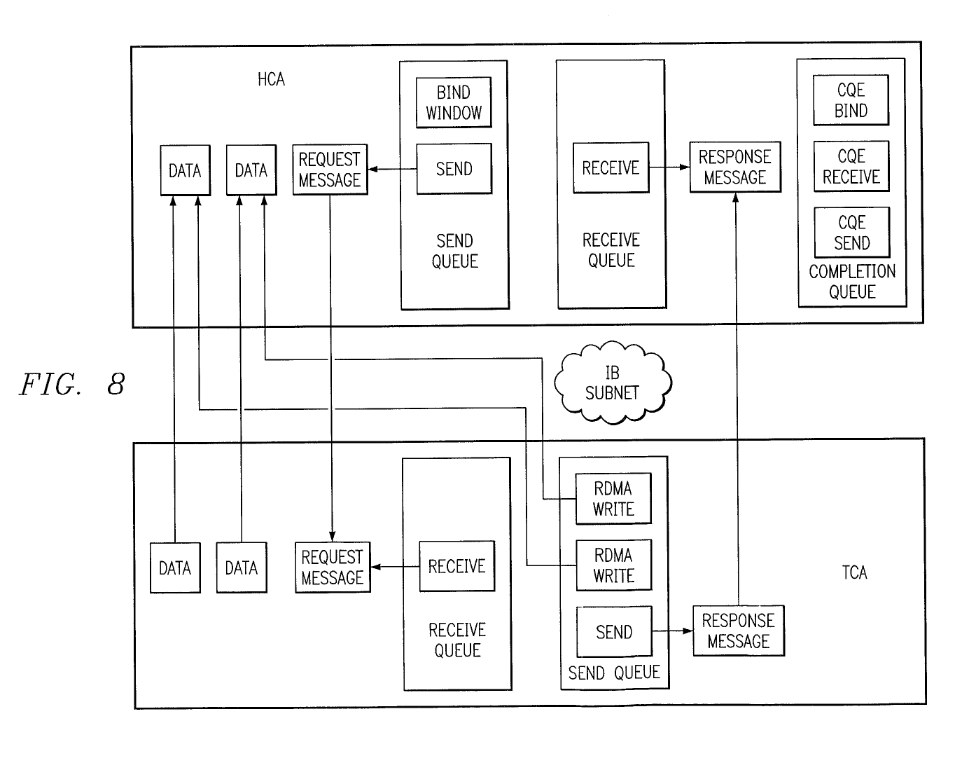

Referring to FIG. 6, a schematic diagram illustrating the relationship between IB components executing basic I/O transmit methodology is depicted in accordance with the present invention. FIG. 7 depicts a flowchart illustrating the process flow of I/O transmit methodology in accordance with the present invention.

The host CPU uses Store instructions to create the data which needs to be transferred to the Ethernet adapter (step 701). The host process which created the data, or an intermediary, invokes the I/O Component's device driver. Before an I/O transmit request is sent to the device driver, the Ethernet adapter must be initialized. First, a Connection Manager protocol exchange sets up an IB connection from the HCA to the TCA with the Ethernet adapter (step 702). Then the request queue depth is obtained from the adapter (step 703). During normal operations, the device driver will never let the number of outstanding I/O transactions be larger than the adapter's request queue depth.

The (host) device driver receives an I/O transaction (step 704). The I/O transaction requests that various Memory Regions (i.e. memory address and length) be transferred from host memory to the adapter, and then transmitted onto media (e.g. cable, fiber) (step 705). The device driver uses an IB Register Memory Region or Bind Memory Window verb to make the I/O transaction's Memory Regions accessible to the IB HCA (step 706).

The device driver uses an IB Post Receive to provision resources for a Transmit Response from the adapter for this Transmit Request (step 707). This step can also come after the following step. The device driver uses processor Store instructions to create a Transmit Request control block for the transfer (step 708). The Transmit Request control block includes: transaction ID (used to correlate the Transmit Response with the Transmit Request); type of command (transmit in this case); list of memory regions and their remote access keys (R_Keys) and total length of the data transfer. The device driver uses an IB Post Send to pass a Work Request, which points to the Transmit Request control block, to the HCA (step 709). The device driver can either continue other work or, if no other work is required, use an IB CQ Notify to request completion notification when the next completion event occurs.

If the device driver used a Bind Memory Window command to make the I/O transaction Memory Regions accessible to the HCA, when the HCA reaches the Bind, it will perform it and, upon completion, cause the CQ handler to be notified (step 710). The device driver then polls the CQ and retrieves a Bind Work Completion (step 711). The device driver can either continue other work or, if no other work is required, use an IB CQ Notify to request completion notification when the next completion event occurs.

When the HCA reaches the Send (of the Transmit Request), it sends the Transmit Request as a single message to the TCA (step 712) and causes the CQ handler to be notified. The Ethernet adapter's TCA receives the Transmit request (step 713). Upon completion of the (Transmit Request) Send, the HCA causes the CQ handler to be notified (step 714). The device driver will then poll the CQ and retrieve a (Transmit Request) Send Work Completion (step 715). The device driver can either continue other work or, if no other work is required, use an IB CQ Notify to request completion notification when the next completion event occurs.

The Ethernet adapter interprets the Transmit Request and retrieves the I/O transaction data from system memory by using Read RDMAs (step 716). The Read RDMAs use the list of remote memory regions and R_Keys that were included in the Transmit request. The Ethernet adapter will then transmit the data on to media (step 717). After all of the data has been successfully transferred in order, the Ethernet adapter creates a Transmit Response control block (step 718). The Transmit Response control block includes: transaction ID (correlating the Request/Response); and completion result (e.g. successful vs. error code). The Ethernet adapter uses an IB Send to transfer the Transmit Response from the TCA to the HCA (step 719). When the Ethernet adapter uses an IB Send to transfer the Transmit response, the HCA causes the CQ handler to be notified (step 720). The device driver will then poll the CQ and retrieve a (Transmit Request) Receive Work Completion (step 721). The device driver can either continue other work or, if no other work is required, use an IB CQ Notify to request completion notification when the next completion event occurs.

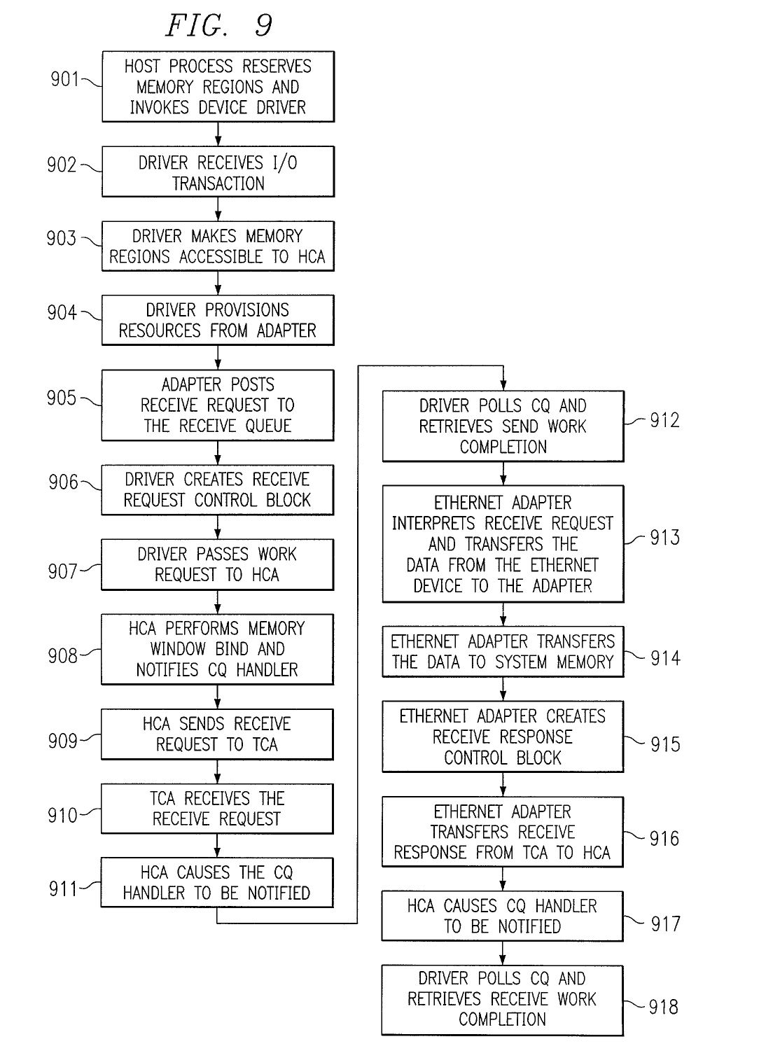

Referring to FIG. 8, a schematic diagram illustrating the relationship between IB components executing an alternate I/O receive methodology is depicted in accordance with the present invention. FIG. 9 depicts a flowchart illustrating the process flow the alternate I/O receive methodology in accordance with the present invention. The receive methodology depicted in FIGS. 8 and 9 uses RDMA commands to automatically send data to the host system via DMAs initiated by the Ethernet chip.

The host process which needs the data from the Ethernet adapter reserves a Memory Region(s) which will be used to contain the data, and invokes the I/O Component's device driver (step 901). The (host) device driver receives an I/O transaction (step 902). The I/O transaction requests that an Ethernet frame be transferred from media to the Ethernet adapter and then from the Ethernet adapter to the host Memory Region which has been reserved by the host process. The device driver uses IB Register Memory Region or Bind Memory Window verb to make the I/O transaction Memory Regions accessible to the IB HCA (step 903). The device driver uses an IB Post Receive to provision resources for a Receive Response from the adapter for the Receive Request (step 904). This step can also come after the following step. The adapter posts Receive Requests to the Receive Queue (RQ) (step 905). The (host) HCA must continually replenish the RQ so that a request is available whenever a received frame comes in from the Ethernet media.

The device driver uses processor Store instructions to create a Receive Request control block for the transfer (step 906). The Receive Request control block includes: transaction ID (used to correlate the Receive Response with the Receive Request); type of command (receive in this case); list of memory regions and their R_Keys; and total length of the data transfer. The device driver uses an IB Post Receive to pass a Work Request, which points to the Receive Request control block, to the HCA (step 907). The device driver can either continue other work or, if no other work is required, use an IB CQ Notify to request completion notification when the next completion event occurs.

If the device driver used a Bind Memory Window verb to make the I/O transaction Memory Region accessible to the HCA, when the HCA reaches the Bind, it will perform it, and upon completion notification , cause the CQ handler to be notified (step 908). The device driver will then poll the CQ and retrieve a Bind Work Completion. The device driver can either continue other work or, if no other work is required, use an IB CQ Notify to request completion notification when the next completion event occurs.

When the HCA reaches the Send (of the Receive Request), it sends the Receive Request as a single message to the Ethernet adapter's request queue (step 909). The Ethernet adapter's TCA receives the Receive Request (step 910). Upon completion of the (Receive Request) Send, the HCA causes the CQ handler to be notified (step 911). The device driver will then poll the CQ and retrieve a (Receive Request) Send Work Completion (step 912). The device driver can either continue other work or, if no other work is required, use an IB CQ Notify to request completion notification when the next completion event occurs.

The Ethernet adapter interprets the Receive Request and transfers the data from the Ethernet device (medium) to the adapter (step 913). The adapter performs necessary processing on the data (e.g. checksum/FCS verification). The Ethernet adapter uses Write RDMAs to transfer the data from the adapter to host system memory (step 914). The Write RDMAs use the list of remote Memory Regions and R_Keys that were included in the Receive Request. After all the data has been successfully transferred in order, the Ethernet adapter creates a Receive Response control block (step 915). The Receive response control block includes: transaction ID (correlating the Request and Response); and completion result (e.g. successful vs. error code). The Ethernet adapter then uses an IB Send to transfer the Receive Response from the TCA to the HCA (step 916). When the HCA completes the receipt of the Receive Response, the HCA causes the CQ handler to be notified (step 917). The device driver will then poll the CQ and retrieve a (Receive Request) Receive Work Completion (step 918). The device driver can either continue other work or, if no other work is required, use an IB CQ Notify to request completion notification when the next completion event occurs.

The present invention may also employ several optimizations in addition to the basic I/O methodologies described above.

For the I/O Transmit, the device driver can use an IB Write RDMA with Immediate Data to push the Transmit Request and the Data to the Ethernet adapter. Immediate Data is four bytes of data which comes with the request so that the user can get some data “immediately”, without having to wait for a RDMA read/write to transmit the requested data to the system. The Immediate Data could contain the adapter side addresses (or address offsets) which the device driver used to store the Transmit request and the Data. To be able to use this optimization, the Ethernet adapter would need to pass the device driver a list of Memory Regions and R_Keys which the Ethernet adapter has reserved to accept Transmit Requests and Data.

A further optimization to the first one noted above is to periodically change the adapter's R_Keys. That is, the R_Keys which provide access control to the adapter's Memory regions and are used to contain Transmit/Receive Requests and Data. The methodology for changing the R_Keys is to include a new R_Key with I/O Transmit Responses.

To remove the need to handle Bind and Send completions, the device driver can use unsignalled completions for most Bind and send operations, then periodically use a singalled Bind or Send to assure previous (unsignaled) work requests completed successfully.

To remove the need to handle Bind, Send, and some Receive completions, the device driver can request CQ Notification only in the case of a solicited event. The adapter can then use solicited events when transferring every N Transmit/Receive Response messages. N represents the (variable, tunable) number of non-solicited event Receive Response messages to transfer before transferring a solicited event Receive Response message.

For I/O Receive methodology, the adapter can use a Write RDMA with Immediate Data to transfer the data and the Receive Response block. Immediate Data is used by the receiving process to make decisions and “steer” data to better destinations.

To simplify the receive methodology, the I/O can use the SEND command which assumes that the host system has pre-allocated buffers to which incoming data is sent.

The Ethernet frame could be sent up in two separate transactions to send the header to one target, and the data to another target.

Multiple QPs can be used to allow multiple HCAs to share a single Ethernet adapter or to demultiplex data in order to send all frames of a particular protocol to a single QP. This would facilitate the normal communication stack architecture used by most operating systems.

To support an I/O virtualization policy, the adapter can use a managed or unmanaged approach. An example of a managed approach comprises using a resource management QP to manage the number of hosts that are allowed to communicate with the adapter and the specific resources assigned to each host (e.g. QPs, header/data buffer, work queue depth, number of QPs, RDMA resources). To facilitate allocation of resources and scheduling events between the hosts, different partition keys (P_Keys) are associated with each host.

An example of an unmanaged approach, involves allowing all hosts to access the adapter's resources under a first come, first served lease model. Under this model, a given host obtains adapter resources and scheduling events (e.g. QPs, header/data buffer space) for a limited time. After the time expires, the host either must renegotiate or give up the resource for another host to use. The resources and time can be preset or negotiated through the IB communication management protocol. As with the managed approach, a unique P_Key can be associated with each host using the I/O resources.

To support differentiated services policy, an adapter's differentiated service policy defines the resources allocated and event scheduling priorities for each service level supported by the adapter. Resource allocation and scheduling can be performed using one of two methods. In the first method, the adapter uses a Relative Adapter Resource Allocation and Scheduling Mechanism. Under this policy, each service level (SL) is assigned a weight. Resources are assigned to a SL by weight. Services that have the same SL share the resources assigned to that SL. For example, an adapter has a 1 GB header/data buffer, and 2 SL's: SL1 with a 3× weight, and SL2 with a 1× weight. If this adapter supports two SL1 connections and two SL2 connections, and all four connections have been allocated, then each SL1 connection gets 384 MB of header/data buffer, and each SL2 connection gets 128 MB of header/data buffer. Similarly, scheduling decisions are made based on S1 weights. Services that have the same S1 share the scheduling events assigned to that SL.

In the second method, each S1 is assigned a fixed number of resources. Services that have the same SL share the resources assigned to that SL. For example, an adapter has a 800 MB header/data buffer, and two SL's. SL1 has 600 MB of space and SL2 has 200 MB of space. If this adapter supports two SL1 and two SL2 connections, then each SL1 connection gets 300 MB of header/data buffer and each SL2 gets 100 MB of header/data buffer. Scheduling decisions are made based on fixed time (or cycle) allocations. Services that have the same SL share the time (or cycle) spent processing operations on that SL. To further support differentiated service policies, an adapter may mix the resource allocation policy, such that some resources are allocated on a relative basis, while others are allocated on a fixed basis.

The support a communication group policy, the adapter can define the number of QPs (with service type for each), and the number of other adapter resources assigned to a given communications group. Under a managed approach, the resources which are to be associated with a communication group are preset either through a resource management QP or during the manufacturing process. The quantities can either be relative (e.g. percentage or multiples) or absolute (except for QPs). Under an unmanaged approach, the resources which are to be associated with a communication group are dynamically negotiated through the IB communication management protocol.

Adapters can support various combinations of resource I/O virtualization, differentiated service, and communication group policies. The adapter's resource management QP is used to set: the number of resources assigned to a given service trough the communication group; the number of communication groups and types of communication groups to a GID; and the scheduling of adapter events based on SL.

Adapters may also be set to not support communication groups and simply select the smaller of the two settings for a specific resource as the maximum resource capacity assigned to a given GID using the I/O adapter.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for transmitting data from a host computer system through an Ethernet adapter, the method comprising:
establishing a connection between the host system and the Ethernet adapter;
pushing a transmit request message from a host system device driver to the Ethernet adapter's request queue;
transferring host memory control to the Ethernet adapter;
reading data, by means of the Ethernet adapter, from a location in host memory specified in the transmit request message; and
transmitting the data onto transmission media by means of the Ethernet adapter.

2. The method according to claim 1, further comprising:
when the data transfer is complete, sending a transmit response message from the Ethernet adapter back to the host system.

3. The method according to claim 2, wherein the transmit response message further comprises:
a transaction ID which correlating request and response; and
a completion result.

4. The method according to claim 1, wherein the step of establishing a connection between the adapter and driver further comprises:
passing information about the depth of the Ethernet adapter's request queue to the device driver, wherein the device driver does not let the number of outstanding transactions exceed the depth of the adapter's request queue.

5. The method according to claim 1, further comprising:
creating a transmit request control block, wherein the control block comprises:
a transaction ID;
type of command (transmit);
a list of memory regions and their remote access keys; and
total length of the data transfer.
sending a work request, which points to the transmit request control block, from the device driver to a host channel adapter.

6. The method according to claim 5, wherein the Ethernet adapter uses read remote direct memory access (RDMA) to read host system memory, wherein the RDMA relies on the list of memory regions and remote access keys contained in the transmit request control block.

7. The method according to claim 1, wherein the step of making host memory accessible to the Ethernet adapter further comprises:
transferring memory regions to the Ethernet adapter's; and
binding memory windows to the transferred memory regions.

8. The method according to claim 1, wherein the step of pushing a transmit request message from the device driver to the Ethernet adapter's request queue further comprises:
passing, from the Ethernet adapter to the device driver, a list of memory regions and remote access keys which the Ethernet adapter has reserved to accept transmit requests and data; and
using a write RDMA with immediate data to push the transmit request, wherein the immediate data contains adapter side addresses which the device driver uses to store the transmit request and data.

9. The method according to claim 1, further comprising:
sending an Ethernet frame in two separate transactions, wherein the frame header and data are sent to different targets.

10. The method according to claim 1, wherein the device driver uses work completions for a portion of all work requests to assure previous work requests completed successfully.

11. The method according to claim 1, further comprising:
using management messages to pre-allocate I/O component resources and schedule events for a plurality of hosts, wherein a different partition key is associated with each host using the I/O component.

12. The method according to claim 1, further comprising:
using management messages to allocate a fixed amount of I/O component resources and schedule events for a plurality of hosts for a specified time period;
wherein a different partition key is associated with each host using the I/O component; and
wherein, upon expiration of the specified time period, the I/O component resources are free and can only be reclaimed through renegotiation by the hosts.

13. The method according to claim 1, further comprising:
allocating I/O component resources and scheduling events for a plurality of hosts according to a specified service level, wherein a different partition key is associated with each host using the I/O component.

14. The method according to claim 13, wherein I/O resources and events are allocated in a relative manner according to a weighted value for each service level.

15. The method according to claim 13, wherein I/O resources and events are allocated in a fixed manner according to an absolute value for each service level.

16. The method according to claim 1, further comprising:
associating I/O component resources with a specified communication group, wherein the adapter designates at least one of the following:
quantity of queue pairs and the service level of each queue pair; and
quantity of other I/O resources.

17. The method according to claim 16, wherein the quantities are specified as relative values.

18. The method according to claim 16, wherein the quantities are specified as absolute values.

19. A method for receiving data through an Ethernet adapter to a host computer system, the method comprising:
establishing a connection between the host system and the Ethernet adapter;
reserving host memory which will be used to contain the data;
pushing a receive request message from a host system device driver to the Ethernet adapter's request queue;
transferring control to the reserved host memory to the Ethernet adapter;
reading data, by means of the Ethernet adapter, from the transmission media; and
writing the data, by means of the Ethernet adapter, to a location in host memory specified in the receive request message.

20. The method according to claim 19, further comprising:
when the data transfer is complete, sending a receive response message from the Ethernet adapter back to the host system.

21. The method according to claim 20, wherein the receive response message further comprises:
a transaction ID which correlating request and response; and
a completion result.

22. The method according to claim 19, wherein the step of establishing a connection between the adapter and driver further comprises:
passing information about the depth of the Ethernet adapter's request queue to the device driver, wherein the device driver does not let the number of outstanding transactions exceed the depth of the adapter's request queue.

23. The method according to claim 19, further comprising:
creating a receive request control block, wherein the control block comprises:
a transaction ID;
type of command (receive);
a list of memory regions and their remote access keys; and
total length of the data transfer.
sending a work request, which points to the receive request control block, from the device driver to a host channel adapter.

24. The method according to claim 23, wherein the Ethernet adapter uses write remote direct memory access (RDMA) to write data to host system memory, wherein the RDMA relies on the list of memory regions and remote access keys contained in the transmit request control block.

25. The method according to claim 19, wherein the step of making host memory accessible to the Ethernet adapter further comprises:
transferring memory regions to the Ethernet adapter's; and
binding memory windows to the transferred memory regions.

26. The method according to claim 19, wherein the adapter uses a write RDMA with immediate data to transfer the data and the receive response block.

27. The method according to claim 19, wherein the Ethernet adapter uses a send command which assumes that the host system has pre-allocated buffers to which incoming data is sent.

28. The method according to claim 19, further comprising:
sending an Ethernet frame in two separate transactions, wherein the frame header and data are sent to different targets.

29. The method according to claim 19, further comprising:
using management messages to pre-allocate I/O component resources and schedule events for a plurality of hosts, wherein a different partition key is associated with each host using the I/O component.

30. The method according to claim 19, further comprising:
using management messages to allocate a fixed amount of I/O component resources and schedule events for a plurality of hosts for a specified time period;
wherein a different partition key is associated with each host using the I/O component; and
wherein, upon expiration of the specified time period, the I/O component resources are free and can only be reclaimed through renegotiation by the hosts.

31. The method according to claim 19, further comprising:
allocating I/O component resources and scheduling events for a plurality of hosts according to a specified service level, wherein a different partition key is associated with each host using the I/O component.

32. The method according to claim 31, wherein I/O resources and events are allocated in a relative manner according to a weighted value for each service level.

33. The method according to claim 31, wherein I/O resources and events are allocated in a fixed manner according to an absolute value for each service level.

34. The method according to claim 19, further comprising:
associating I/O component resources with a specified communication group, wherein the adapter designates at least one of the following:
quantity of queue pairs and the service level of each queue pair; and
quantity of other I/O resources.

35. The method according to claim 34, wherein the quantities are specified as relative values.

36. The method according to claim 34, wherein the quantities are specified as absolute values.

37. A system for transmitting data from a host computer system to an Ethernet adapter, the system comprising:
a communication component which establishes a connection between the host system and the Ethernet adapter;
a pushing component in a host system device driver which pushes a transmit request message to the Ethernet adapter's request queue;
a register which transfers host memory access to the Ethernet adapter;
a reading component in the Ethernet adapter which reads data from a location in host memory specified in the transmit request message; and
a transmitting component in the Ethernet adapter which transmits the data onto transmission media.

38. A system for receiving data from an Ethernet adapter to a host computer system, the system comprising:
a communication component which establishes a connection between the host system and the Ethernet adapter;
a register which reserves host memory which will be used to contain the data;
a pushing component in a host system device driver which pushes a receive request message to the Ethernet adapter's request queue;
a register which transfers host memory access to the Ethernet adapter;
a receiving component in the Ethernet adapter which receives data from the transmission media; and
a writing component in the Ethernet adapter which writes the data to a location in host memory specified in the receive request message.
